(19) United States
(12) Patent Application Publication
(10) Pub. No.: US 2026/0330274 A1
(43) Pub. Date: Oct. 22, 2026

(54) INSERTING AND CALIBRATING COMPENSATION PHASES IN QUANTUM CIRCUITS

(71) Applicant: Google LLC, Mountain View, CA (US)

(72) Inventors: Alexandre Bourassa, Santa Barbara, CA (US); Kevin Satzinger, Goleta, CA (US); Craig Gidney, Goleta, CA (US)

(21) Appl. No.: 19/071,221

(22) Filed: Mar. 5, 2025

(51) Int. Cl. G06N 10/20; G06N 10/70

(52) U.S. Cl. CPC G06N 10/20; G06N 10/70

(57) ABSTRACT

Methods, systems, and apparatus for inserting and calibrating compensation operations in quantum circuits. One or more operations in a quantum circuit that each violate a generalized commutation relation with a compensation operation are identified, where the compensation operation counteracts uncontrolled qubit rotations. The compensation operation is inserted directly before each of the one or more operations in the quantum circuit that violate the commutation relation with the compensation operation. Rotation angles of the compensation operations inserted into the quantum circuit are then calibrated. Rotation angles in a group of rotation angles that have non-overlapping sets of detectors can be calibrated in parallel.

### BACKGROUND

This specification relates to quantum computing.

Calibration in a quantum computer is the process of characterizing, tuning, and optimizing qubit operations to ensure high-fidelity quantum computations. Qubits are highly sensitive to noise, drift, and hardware imperfections. Calibration involves adjusting operating parameters, e.g., qubit frequencies, gate pulse parameters, and measurement readout settings to maintain stability and accuracy. Calibration can be performed before a quantum computation is executed (pre-calibration) to set values of the operating parameters and during execution of a quantum computation (in-context calibration) to dynamically adapt to system fluctuations in real time.

### SUMMARY

This specification describes technologies for inserting and calibrating compensation operations in quantum circuits.

In general, one innovative aspect of the subject matter described in this specification can be implemented in a method that includes identifying one or more operations in a quantum circuit that each violate a commutation relation with a compensation operation, wherein the compensation operation counteracts uncontrolled qubit rotations; inserting the compensation operation directly before each of the one or more operations in the quantum circuit that violate the commutation relation with the compensation operation; and calibrating rotation angles of the compensation operations inserted into the quantum circuit.

Other implementations of these aspects include corresponding computer systems, apparatus, and computer programs recorded on one or more computer storage devices, each configured to perform the actions of the methods. A system of one or more quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations calibrating rotation angles of the compensation operations inserted into the quantum circuit comprises: determining, for each compensation operation, a set of detectors triggered by propagation of an error caused by the compensation operation through the circuit; determining a plurality of groups of compensation operations, wherein compensation operations in a same group have non-overlapping sets of detectors; and calibrating rotation angles of compensation pulses in each group.

In some implementations the method further comprises calibrating rotation angles of compensation pulses in each group in parallel.

In some implementations determining the plurality of groups of compensation operations comprises: mapping the compensation operations and sets of detectors to a graph, wherein each node in the graph represents a respective compensation operation and two nodes are connected by an edge when the sets of detectors for the two nodes overlap; performing a graph colouring algorithm to assign colours to the nodes in the graph, wherein adjacent nodes are assigned different colours; and grouping compensation operations that correspond to nodes in the graph with a same colour in a same group.

In some implementations determining, for each compensation operation, a set of detectors triggered by propagation of an error caused by the compensation operation through the circuit comprises performing a Tableau simulation using a Tableau simulation tool.

In some implementations the detectors comprise detectors or measured deviations from known circuit outputs.

In some implementations the one or more operations in the quantum circuit that each violate the commutation relation with the compensation operation excludes operations in the quantum circuit that violate the commutation relation with the compensation operation and directly preceded by a reset operation.

In some implementations an operation violates the commutation relation with the compensation operation if an action of the operation is modified by the compensation operation up to a global phase.

In some implementations the operation is a single qubit operation and commutation relation is given by Rᵢ(α, θ₁)U=e^{iφ}URᵢ(α, θ₁), where U represents the single qubit operation in the quantum circuit that acts on qubit i, Rᵢ(α, θ₁) represents a compensation operation applied to qubit i where a represents a normalized vector around which to rotate and θ₁ represents a rotation angle of the compensation operation Rᵢ, and e^{iφ} represents a global phase with free parameter φ.

In some implementations the operation is a two-qubit operation and the commutation relation is given by Rᵢ(α, θ₁)U=e^{iφ}URⱼ(β, θ₂), where U represents the two-qubit operation in the quantum circuit that acts on qubits i and j, Rᵢ(α, θ₁) represents a compensation operation applied to qubit i where a represents a normalized vector around which to rotate and θ₁ represents a rotation angle of the compensation operation Rᵢ, Rᵢ(β, θ₂) represents a compensation operation applied to qubit j where β represents a normalized vector around which to rotate and θ₂ represents a rotation angle of the compensation operation Rⱼ, and e^{iφ} represents a global phase with free parameter φ.

In some implementations the method further comprises partitioning the quantum circuit that comprises the compensation operations into a plurality of subsections; generating an identifier of each subsection, comprising applying a hash function to each subsection; determining that multiple subsections have a same identifier; calibrating rotation angles of compensation operations in one subsection of the multiple subsections; and propagating the calibrated rotation angles to respective compensation operations in other subsections of the multiple subsections.

In some implementations each subsection in the plurality of subsections is delimited by a respective measurement and reset operation.

In some implementations propagating the calibrated rotation angles to respective compensation operations in other subsections of the multiple subsections comprises inserting an additional compensation operation at a start of each other subsection.

In some implementations generating an identifier of a subsection of the quantum circuit comprises applying a hash function to the subsection to obtain a first hash value; applying a hash function to a subsection that directly precedes the subsection to obtain a second hash value; and combining the first hash value and the second hash value to obtain the identifier of the subsection.

In some implementations the quantum circuit comprises quantum error correction circuit or an error mitigation circuit.

In some implementations the compensation operation comprises an X, Y, or Z-phase compensation rotation.

In some implementations the method further comprises storing the calibrated rotation angles in a control and measurement system included in the quantum computing device.

In some implementations the method further comprises retrieving, by the control and measurement system, the calibrated rotation angles to execute the quantum circuit.

In general, another innovative aspect of the subject matter described in this specification can be implemented in a method performed by a calibration system in data communication with a quantum computing device running an error correction procedure on a plurality of qubits, the method including: monitoring error detection events that indicate a presence of errors occurring on the plurality of qubit; and calibrating, in parallel with the error correction procedure, rotation angles of compensation operations that operate on respective qubits of the plurality of qubits, comprising: determining, using the monitored error detection events and for each compensation operation, a set of detectors triggered by propagation of an error caused by the compensation operation; determining a plurality of groups of compensation operations, wherein compensation operations in a same group have non-overlapping sets of detectors; and calibrating rotation angles of compensation pulses in each group in parallel.

Other implementations of these aspects include corresponding computer systems, apparatus, and computer programs recorded on one or more computer storage devices, each configured to perform the actions of the methods. A system comprising a calibration system in data communication with a quantum computing device running an error correction procedure on a plurality of qubits can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The subject matter described in this specification can be implemented in particular ways so as to realize one or more of the following advantages.

Quantum computers require a lot of calibration to perform quantum computations with target accuracy. Some calibrations can be performed independently on individual quantum gates in a quantum circuit. Other calibrations are performed in the context of a specific quantum circuit, e.g., based on the circuit structure and execution conditions. For example, compensation operations can be inserted into a quantum circuit based on an error signal, e.g., detection event fraction.

Examples of the present disclosure automatically determine locations in a quantum circuit at which to insert compensation operations to optimally counteract accumulated phase errors. Accordingly, the resulting quantum circuit can perform quantum computations with higher fidelity, e.g., compared to quantum circuits that include manually inserted compensation operations. In addition, the resulting quantum circuit can be executed with reduced execution time and efficiency, e.g., compared to quantum circuits that include manually inserted compensation operations and typically require repeated circuit tuning and testing. In addition, the automatic technique for determining locations in a quantum circuit at which to insert compensation operations is scalable to large quantum circuits.

Further, as the size of quantum computers grows to hundreds or thousands of qubits, sequential calibration of compensation operations becomes infeasible. However, examples of the present disclosure automatically identifies groups of compensation operations that can be calibrated in parallel, which reduces total calibration time and enables scalability to large quantum circuits. This is particularly beneficial in the fault tolerant quantum computing regime since quantum error correction and quantum error mitigation rely on fast and accurate calibration.

In addition, examples of the present disclosure identify instances in a quantum circuit where calibrated compensation operation rotation angles can be re-used without affecting their ability to optimally counteract accumulated phase error. Therefore, redundant calibrations are avoided, and the required total number of calibrations is reduced.

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example quantum computing system that implements in-context calibration using compensation phases.

FIG. 2 is a block diagram of the example in-context calibration system of FIG. 1 during an example in-context calibration process.

FIG. 3A is a circuit diagram of an example quantum circuit.

FIG. 3B is a circuit diagram that shows example candidate locations for inserting a compensation operation in example quantum circuit.

FIG. 3C is a circuit diagram that shows locations in which to insert the compensation operation.

FIG. 4 shows an example graph that represents compensation operations and sets of detectors for the compensation operations and an example coloring of the example graph.

FIG. 5 is a circuit diagram of a quantum circuit that has been partitioned into multiple subsections.

FIG. 6 is a flow diagram of an example process for inserting compensation operations in a quantum circuit.

FIG. 7 is a flow diagram of an example process for calibrating compensation operations in a quantum circuit in parallel.

FIG. 8 is a flow diagram of an example process for calibrating compensation operations in-situ whilst error correction is running.

### DETAILED DESCRIPTION

This specification describes techniques for in-context calibration in a quantum computing device. To account for uncontrolled qubit rotations during execution of a quantum circuit, compensation operations, e.g., compensation phase gates, are added to the quantum circuit. Precise circuit locations at which to insert the compensation operations are determined using a generalized commutation relation. Inserted compensation operations can be grouped based on detectors triggered by the compensation operations, which enables compensation operations within a same group to be calibrated in parallel. Calibrated compensation operations that can be re-used in different sections of the quantum circuit are identified using unique identifiers of subsections of the quantum circuit.

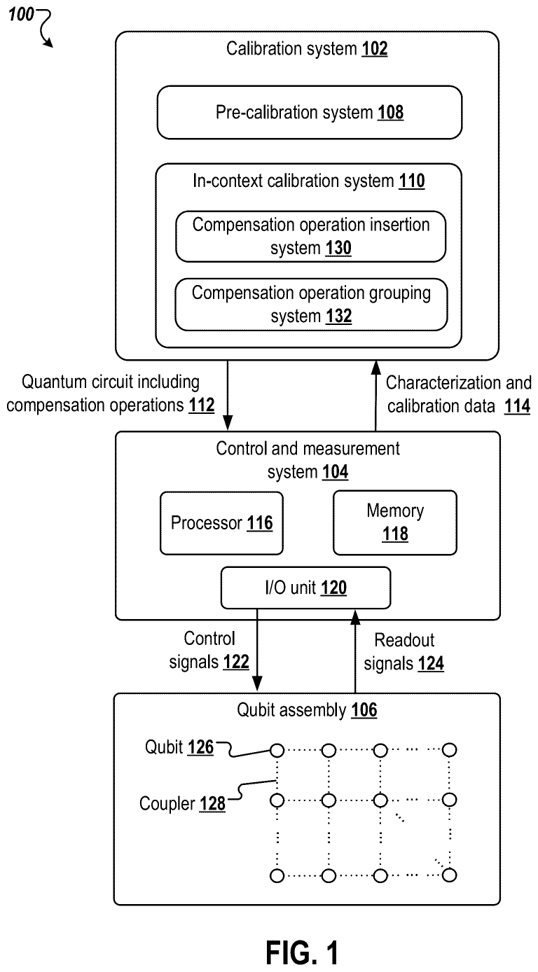

FIG. 1 is a block diagram of an example quantum computing system 100 that implements in-context calibration using compensation phases. The system 100 is an example of a system implemented using one or more classical and quantum computing devices in one or more locations, in which the systems, components, and techniques described in this specification can be implemented. The system 100 includes a calibration system 102, control and measurement system 104, and qubit assembly 106. Components of the system 100 can communicate with each other through data communication links, e.g., through a communication network such as a local area network or wide area network, or through dedicated hardware interconnects.

The calibration system 102 is a classical computing system that is configured to calibrate, e.g., adjust and optimize, operating parameters of the system 100. Example operating parameters include, but are not limited to, qubit operating frequencies, quantum gate parameters, measurement operations, etc. The calibration system 102 includes a pre-calibration system 108 and an in-context calibration system 110.

The pre-calibration system 108 is configured to perform calibrations of operating parameters before a quantum computation is executed by the system 100. The calibrated values are then fixed during execution of the quantum computation. For example, the pre-calibration system 108 can be configured to perform quantum gate characterization and benchmarking to optimize gate fidelities of single-qubit and two-qubit gates included in a quantum circuit. These gate optimizations can be performed independently on individual gates in the quantum circuit. Other example calibrations performed by the pre-calibration system 108 include, e.g., calibrations of qubit operating frequencies to reduce crosstalk, readout calibration to improve the discrimination between measured qubit state, or microwave pulse shape optimization to improve the precision of quantum gate execution. Calibrated values of operating parameters can be stored by the control and measurement system 104 and retrieved as needed when a quantum computation is executed.

The in-context calibration system 110 is configured to perform calibrations in the context of a specific quantum computation, e.g., based on a circuit structure and execution conditions. For example, the in-context calibration system 110 is configured to insert and tune compensation operations in a quantum circuit. The compensation operations include single-qubit operations that are applied to respective qubits to counteract unwanted (i.e., uncontrolled) phase shifts. The phase compensation operations can be X, Y, or Z phase compensation operations.

X-phase compensation operations correct phase errors that cause a qubit to unintentionally rotate around the X-axis of the Bloch sphere, e.g., due to drive imperfections. A X-phase compensation operation applies a corrective rotation

$${R}_{X} ( θ ) = {e}^{- i \frac{θ}{2} X}$$

around the X axis of the Bloch sphere, where the value of the rotation angle θ is chosen to negate the accumulated phase error.

Similarly, Y-phase compensation operations correct phase errors that cause a qubit to unintentionally rotate around the Y-axis of the Bloch sphere, e.g., due to off-axis errors in qubit control pulses. A Y-phase compensation operation applies a corrective rotation R_{Y}(θ)=

$${e}^{- i \frac{θ}{2} Y}$$

around the Y axis of the Bloch sphere, where the value of the rotation angle θ is chosen to negate the accumulated phase error.

Z-phase compensation operations correct phase errors that accumulate in the computational basis, e.g., due to hardware imperfections or frequency detunings. For example, in some qubit platforms such as those that include superconducting qubits, the state of a qubit is manipulated through the application of microwave pulses that induce X or Y rotations. However, when idle, the qubit state naturally evolves under the Z Hamiltonian, leading to uncontrolled Z-phase accumulation in the computational basis. As another example, implementations of two-qubit gates, e.g., CNOT or CZ gates, can cause Z-phase errors to accumulate on the target qubit.

A Z-phase compensation operation applies a corrective rotation

$${R}_{Z} ( θ ) = {e}^{- i \frac{θ}{2} Z}$$

around the Z axis of the Bloch sphere, where the value of the rotation angle θ is chosen to negate the accumulated phase error. In some implementations, Z-phase compensation operations can be applied virtually by adjusting the reference frame in subsequent control pulses applied to the qubit instead of physically applying a separate Z-phase compensation operation.

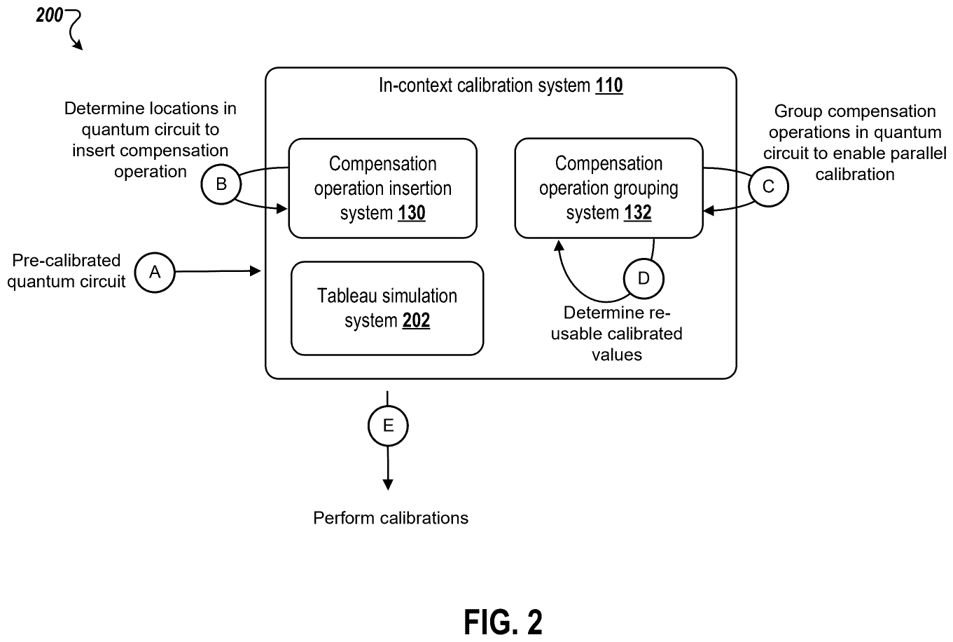

The in-context calibration system 110 includes a compensation operation insertion system 130 that is configured to determine precise locations in a quantum circuit at which to insert a compensation operation. The in-context calibration system 110 further includes a compensation operation grouping system 132 that is configured to identify groups of compensation operations, where compensation operations within a same group can be calibrated by the calibration system 102 in parallel. Example operations performed by the in-context calibration system 110 to insert and tune compensation operations in a quantum circuit are described in more detail below with reference to FIG. 2.

The control and measurement system 104 is an example of a classical computer system that can be used to perform various operations on the qubit assembly 106, as well as other classical subroutines or computations. The control and measurement system 104 includes one or more classical processors, e.g., classical processor 116, one or more memories, e.g., memory 118, and one or more I/O units, e.g., I/O unit 120, connected by one or more data buses. The control and measurement system 104 can be programmed to send sequences of control signals 122 to the qubit assembly 106, e.g. to carry out a selected series of quantum gate operations, and to receive sequences of readout signals 124 from the qubit assembly 106, e.g. as part of performing measurement operations.

The processor 116 is configured to process instructions for execution within the control and measurement system 104. The processor 116 can be a single-threaded processor or a multi-threaded processor. The processor 116 is capable of processing instructions stored in the memory 118. The memory 118 stores information within the control and measurement system 104. The memory 118 can include a computer-readable medium, a volatile memory unit, and/or a non-volatile memory unit. In some cases, the memory 118 can include storage devices capable of providing mass storage for the control and measurement system 104, e.g. a hard disk device, an optical disk device, a storage device that is shared over a network by multiple computing devices (e.g., a cloud storage device), and/or some other large capacity storage device.

The input/output unit 120 provides input/output operations for the control and measurement system 104. The input/output unit 120 can include, e.g., D/A converters, A/D converters, and RF/microwave/optical signal generators, transmitters, and receivers, whereby to send control signals 122 to and receive readout signals 124 from the qubit assembly 106, as appropriate for the physical scheme for the quantum computing system 100. In some implementations, the input/output unit 120 can also include one or more network interface devices, e.g., an Ethernet card, a serial communication device, e.g., an RS-232 port, and/or a wireless interface device, e.g., an 802.11 card. In some implementations, the input/output unit 120 can include driver devices configured to receive input data and send output data to other external devices, e.g., keyboard, printer and display devices.

The qubit assembly 106 includes multiple qubits, e.g., qubit 126, that are used to perform algorithmic operations or quantum computations. While the qubits shown in FIG. 1 are arranged in a rectangular array, this is a schematic depiction and is not intended to be limiting. The qubit assembly 106 can also include adjustable coupling elements, e.g., coupler 128, that allow for interactions between coupled qubits. In the example shown in FIG. 1, each qubit is adjustably coupled to each of its four adjacent qubits by means of respective coupling elements. However, this is an example arrangement of qubits and couplers, other arrangements are possible, including arrangements that are non-rectangular, arrangements that allow for coupling between non-adjacent qubits, and arrangements that include adjustable coupling between more than two qubits.

Each qubit is a physical two-level quantum system or device having levels representing logical values of 0 and 1. The specific physical realization of the multiple qubits and how they interact with one another is dependent on a variety of factors including the type of the quantum computing system 100 or the type of quantum computations that the quantum computing device is performing. For example, in a superconducting quantum computer the qubits may be realized via superconducting qubits or semi-conducting qubits, e.g., superconducting transmon states. As another example, in an atomic quantum computer the qubits may be realized via atomic, molecular or solid-state quantum systems, e.g., hyperfine atomic states. As another example, in a NMR quantum computer the qubits may be realized via nuclear spin states.

In some implementations a quantum computation can proceed by loading qubits, e.g., from a quantum memory, and applying a quantum circuit to the qubits. The quantum circuit includes a sequence of unitary operations, e.g., quantum logic gates. The quantum logic gates include single-qubit gates, e.g., Pauli-X, Pauli-Y, Pauli-Z (also referred to as X, Y, Z), Hadamard gates, S gates, X, Y, or Z rotations (including the above described compensation operations). The quantum logic gates can further include two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 122 generated by the control and measurement system 104 to the qubits and to the couplers.

In some implementations the qubits in the qubit assembly 106 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 122 used depends on the physical realizations of the qubits. For example, the control signals 122 may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 122. The measurements cause readout signals 124 representing measurement results to be communicated back to the measurement and control system 104. The readout signals 124 may include RF, microwave, or optical signals depending on the physical scheme for the quantum computing system and/or the qubits in the qubit assembly 106.

FIG. 2 is a block diagram 200 of the example in-context calibration system 110 of FIG. 1 during an example in-context calibration process. The block diagram 200 illustrates the example process as including stages (A)-(E). However, in some implementations the process can include fewer or more stages.

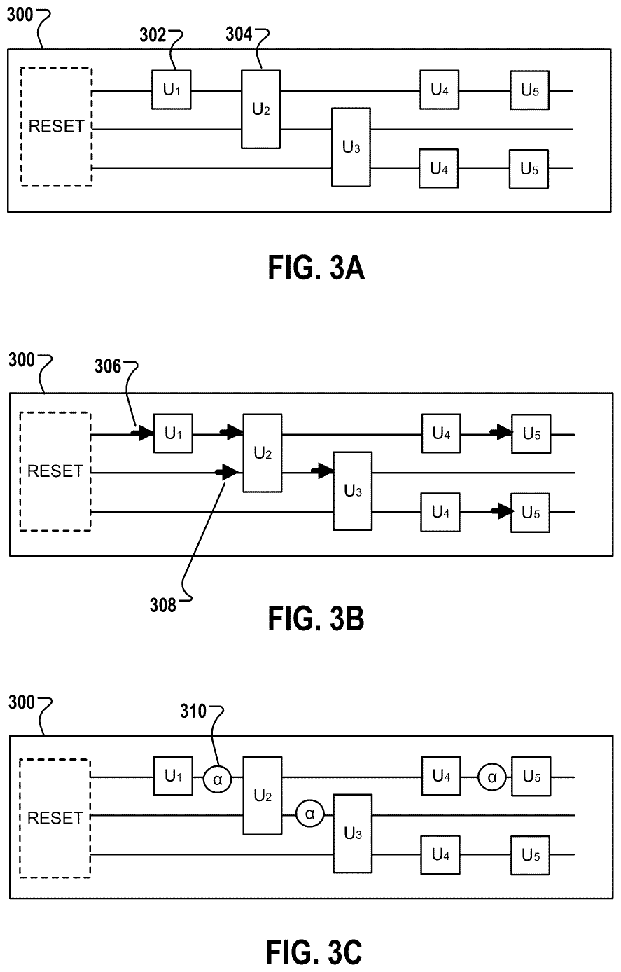

During stage (A) of the example in-context calibration process, the in-context calibration system 110 obtains data representing a quantum circuit. The quantum circuit operates on multiple qubits and includes multiple unitary operations, e.g., quantum logic gates. An example quantum circuit is shown and described below with reference to FIG. 3A.

The quantum circuit is a circuit that has some known expected outputs that can be used to detect or mitigate errors. For example, in some implementations the quantum circuit can be a quantum error correction circuit. A quantum error correction circuit is a quantum circuit that encodes logical qubits into multiple physical qubits to detect and correct errors, e.g., caused by decoherence, noise, or gate imperfections. The physical qubits include data qubits that encode a logical state of the underlying computation and ancilla qubits (also referred to as syndrome qubits) that measure error syndromes without collapsing the logical state. Measured error syndromes can be decoded to determine corrective operations that can be implemented to maintain quantum coherence and fidelity of the computation.

As another example, in some implementations the quantum circuit can be an error mitigation quantum circuit. An error mitigation quantum circuit can use ancilla qubits or measurement devices to identify errors and apply techniques, e.g., measurement correction, extrapolation, post-selection, or adaptive control, to reduce the impact of the errors on the underlying quantum computations without using full quantum error correction.

During stage (B), the compensation operation insertion system 130 determines precise locations in the quantum circuit at which to insert a compensation operation. The compensation operation insertion system 130 determines whether each operation in the quantum circuit satisfies or violates a generalized commutation relation with the compensation operation. An operation satisfies the generalized commutation relation with the compensation operation if the operation and the compensation operation commute up to a global phase (which is why the commutation relation is referred to as a generalized commutation relation). For example, the generalized commutation relation can be given by

Rᵢ(α,θ₁)U=e^{iφ}URⱼ(β,θ₂),

where U represents the unitary operation in the quantum circuit, Rᵢ(α, θ₁) represents the compensation operation applied to qubit i where a represents a normalized vector around which to rotate (e.g., represents the Z, X, or Y axis) and θ₁ represents the rotation angle of operation Rᵢ, Rⱼ(β, θ₂) represents the compensation operation applied to qubit j where β represents a normalized vector around which to rotate (e.g., represents the Z, X, or Y axis) and θ₂ represents the rotation angle of operation Rⱼ, and e^{iφ} represents a global phase with free parameter φ (where the qubits i and j are the qubits participating in the unitary operation, e.g., if the unitary operation is a single qubit operation then i=j or if the unitary operation is a two-qubit operation then the unitary operation acts on both qubits i and j).

Determining whether the generalized commutation relation is satisfied or not enables the compensation operation insertion system 130 to determine whether the compensation operation would commute, up to the global phase, with the unitary operation. If the commutation relation is satisfied, then the unitary operation is deemed trivial in the sense that insertion of the compensation operation before the unitary operation is equivalent to inserting a compensation operation after the unitary operation, therefore compensation operations required to counteract uncontrolled rotations that occur before the unitary operation can be pushed deeper into the circuit. Example unitary operations that are trivial in this sense (with respect to Z rotations) include, e.g., X, Y, Z, CZ, or iSWAP gates. An example unitary operation that is trivial with respect to X rotations is

$${R}_{X} ( \frac{π}{3} ) .$$

Example non-trivial unitary operations (with respect to Z rotations) include, e.g., H, SqrtiSWAP, Rx(pi/3) gates, etc. Some unitary operations can be partially trivial, e.g., the CNOT gate which is trivial for the control qubit and non-trivial for the target qubit.

The compensation operation insertion system 130 determines an initial set of locations (candidate locations) at which to insert the compensation operation as directly before each unitary operation that does not satisfy the generalized commutation relation, i.e., directly before each non-trivial unitary operation. An example set of candidate locations for inserting a compensation operation is shown and described below with reference to FIG. 3B.

The compensation operation insertion system 130 removes locations from the initial set of locations that are preceded by a reset operation (where the reset operation operates in the same basis as the rotations the compensation operation counteracts). This is because, in these cases the qubit has been prepared in a known state and so the compensation operation is arbitrary. In some implementations the compensation operation insertion system 130 can use a simulation tool, e.g., a Tableau simulation tool 202, to identify instances of the inserted compensation operations that are equivalent and remove one of the instances from the quantum circuit. Two compensation operations are equivalent if they produce the same net effect on all qubits.

The remaining locations are then determined as locations at which to insert the compensation operation. An example set of locations at which to insert a compensation operation is shown and described below with reference to FIG. 3C.

Once the in-context calibration system 110 determines locations in the quantum circuit at which to insert a compensation operation, the system determines an amount of rotation needed at each location, i.e., rotation angles of the compensation operations are calibrated. In some implementations, the in-context calibration system 110 can perform serial calibrations of the rotation angles of the compensation operations, e.g., using a parameter sweep approach where each rotation angle is swept over a predetermined range of angles and the resulting detection event fraction signal is monitored to identify an optimal rotation angle. However, this is computationally inefficient since the number of such rotation angles can in practice be very large and scales with the number of qubits.

Therefore, during stage (C), the compensation operation grouping system 132 identifies groups of compensation operations, where compensation operations within a same group can be calibrated in parallel. The compensation operation grouping system 132 determines, for each compensation operation, a set of detectors that are affected by the compensation operation. For example, the compensation operation grouping system 132 can perform a simulation, e.g., Tableau simulation to propagate an error through the quantum circuit. For example, in cases where the compensation operation is a Z-phase compensation operation, the Tableau simulation can propagate a Z Pauli error through the quantum circuit and in cases where the compensation operation is a X-phase compensation operation, the Tableau simulation can propagate an X Pauli error through the quantum circuit, etc. The compensation operation grouping system 132 can then determine a set of detectors, that are triggered by the propagation of the error.

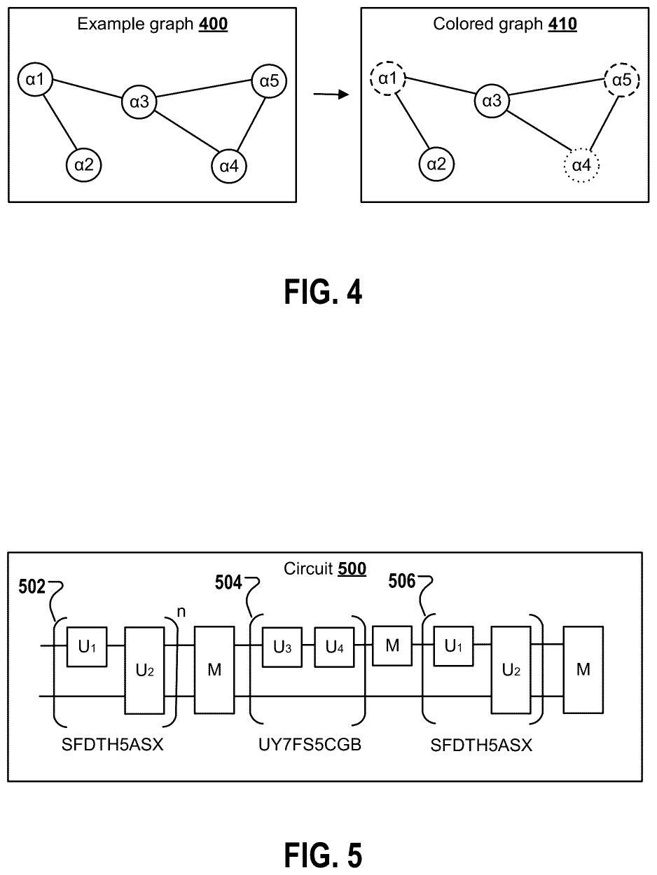

The compensation operation grouping system 132 uses the sets of detectors to generate a graph (or generate a data structure that represents a graph), where each node in the graph corresponds to a respective compensation operation and two nodes in the graph are connected by an edge if and only if there is an overlap between the detector sets of the two nodes. The compensation operation grouping system 132 can then perform a graph coloring algorithm to color the nodes of the graph, where adjacent nodes are colored in different colors. Compensation operations corresponding to nodes that have been colored in a same color can then form a group of compensation operations that can be calibrated in parallel. An example graph and colored graph are shown and described in more detail below with reference to FIG. 4.

Since many quantum circuits include repeating sequences of operations, in some implementations a same calibrated value of a compensation operation rotation angle can be re-used at similar locations in the quantum circuit. Therefore, during stage (D), the compensation operation grouping system 132 identifies locations at which a calibrated rotation angle can be re-used.

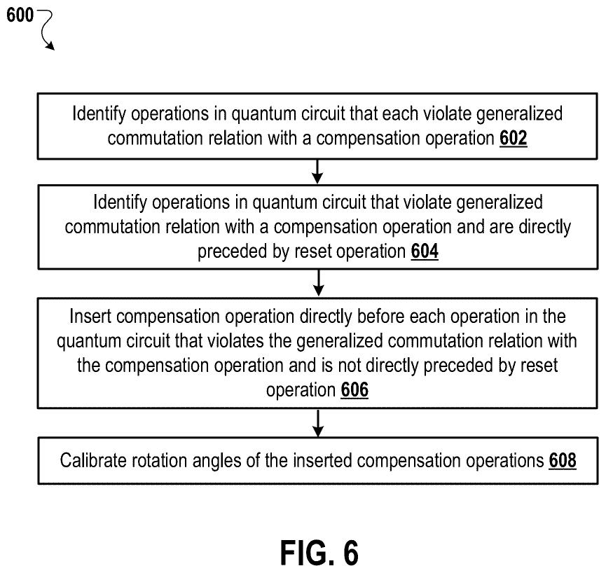

The compensation operation grouping system 132 partitions the quantum circuit into multiple subsections. For example, the quantum circuit can be partitioned into subsections where each subsection is delimited by a respective measurement and reset operation. However, other grouping heuristics can also be used to partition the quantum circuit. The compensation operation grouping system 132 then assigns each subsection an identifier based on the unitary operations included in the subsection. The identifiers can be assigned such that if two subsections include a same sequence of unitary operations, both subsections will be assigned a same identifier, whereas if two subsections include different sequences of unitary operations, the subsections will be assigned different identifiers. The compensation operation grouping system 132 can generate the identifiers through an application of a hash function to text or matrix representation of the subsections, as described in more detail below with reference to FIG. 6. An example partitioned quantum circuit and assigned identifiers is shown and described below with reference to FIG. 5.

In some implementations the above described assignment of identifiers may not be sufficient since previous subsections in the quantum circuit can affect later subsections in the quantum circuit. Therefore, even if two subsections of the quantum circuit include the same sequence of unitary operations, the uncontrolled rotations that qubits incur in the respective subsections can differ. In these implementations, the compensation operation grouping system 132 can salt the above described identifiers. In cases where a subsection is sequentially repeated, no salt is applied to the identifier. However, the subsection can be preceded by an additional phase compensation operation. Otherwise, a circuit subsection can be salted with an identifier of a circuit subsection that directly precedes the subsection (which may or may not have been salted). For example, the compensation operation grouping system 132 can combine an identifier of the circuit subsection that directly precedes the subsection with the identifier of the subsection.

The compensation operation grouping system 132 identifies multiple subsections that have a same identifier. The compensation operation insertion system 130 can then determine to keep compensation operations in one of the subsections with the same identifier in the groups generated during stage (C) and remove the compensation operations in the remaining subsections that have the same identifier from the groups. In this manner, the number of compensation operations that require calibrating is reduced.

During stage (E), the in-context calibration system 110 performs calibrations of the compensation operations inserted into the quantum circuit during stage (B). The calibrations can be performed serially or in parallel according to the groups defined during stage (C). In some implementations the calibrations can be performed using a parameter sweep approach. In these implementations, a portion of the quantum circuit that includes a particular compensation operation on a respective qubit (e.g., all operations in the quantum circuit up to and including the particular compensation operation that are applied to the respective qubit) is repeatedly applied for each of multiple rotation angles over a predetermined range of angles, e.g., the range [−π,π]. In some implementations the ordering of the angles can be randomized when sweeping in parallel to avoid coherent effects. A resulting error signal, e.g., error detection event fraction signal, can then be analyzed to identify a rotation angle that maximally aligns the qubit state with an expected qubit state. In other implementations the calibrations can be performed using an adaptive optimization algorithm (e.g., Bayesian inference or a machine learning based optimizer) or phase estimation based calibration method (e.g., a Ramsey experiment).

FIG. 3A is a circuit diagram of an example quantum circuit 300. The example quantum circuit 300 shown in FIG. 3A operates on three qubits, each represented by a respective horizontal line, and includes multiple unitary operations U₁-U₅. However, this is for illustrative purposes only and in practice the quantum circuit can operate on a larger number of qubits and include more unitary operations. The unitary operations include single qubit operations, e.g., unitary operation 302. The unitary operations further include two-qubit operations, e.g., unitary operation 304. The unitary operations U₁-U₅ are preceded by a reset operation that initializes the qubits in a known state, e.g., the zero state.

FIG. 3B is a circuit diagram that shows example candidate locations for inserting a compensation operation in example quantum circuit 300. In this example, single qubit unitary operation U₁ violates the generalized commutation relation and does not commute up to a phase with the compensation operation. That is, U₁ does not satisfy R₁(α, θ₁)U₁=e^{iφ}U₁R₁(α, θ₁), where R₁(α, θ₁) represents the compensation operation applied to qubit 1 and e^{iφ} represents a global phase. Similarly, single qubit unitary operation U₅ applied to both the first and third qubit violates the generalized commutation relation and does not commute up to a phase with the compensation operation.

Further, two-qubit unitary operation U₂ violates the generalized commutation relation and does not commute up to a phase with the compensation operation. That is, U₂ does not satisfy R₁(α, θ₁)U₂=e^{iφ}U₂R₂(β, θ₂) or R₂(α, θ₁)U₂=e^{iφ}U₂R₁(β, θ₂) where R₁(β, θ₂) represents the compensation operation applied to qubit 1, R₂(α, θ₁) represents the compensation operation applied to qubit 2, and e^{iφ} represents a global phase. Similarly, U₃ does not satisfy R₂(α, θ₁)U₃=e^{iφ}U₃R₃(β, θ₂) where R₂(α, θ₁) represents the compensation operation applied to qubit 2, R₃(β, θ₂) represents the compensation operation applied to qubit 3, and e^{iφ} represents a global phase.

Conversely, single qubit unitary operation U₄ does not commute up to a phase with the compensation operation applied to qubits 1 and 3 and two-qubit unitary operation U₃ does commute up to a phase with the compensation operation applied to qubit 3.

FIG. 3C is a circuit diagram that shows locations in which to insert the compensation operation, e.g., location 310. In this example, the locations correspond to the candidate locations shown in FIG. 3B, with the exception that candidate locations that are preceded by the reset operation have been removed, e.g., locations 306 and 308 have been removed.

FIG. 4 shows an example graph 400 that represents compensation operations and sets of detectors for the compensation operations and an example coloring of the example graph. Each node in the graph represents a respective compensation operation. Each edge that connects a respective pair of nodes in the graph indicates that the sets of detectors for the two nodes in the pair overlap. The example graph 400 shown in FIG. 4 includes only five nodes, however in practice the graph could include a larger number of nodes.

After the coloring algorithm is performed, the nodes are assigned colors such that adjacent nodes have different colors to generate a colored graph 410. Compensation operations that correspond to nodes in the colored graph 410 that have a same color can be calibrated in parallel. For example, in the example shown in colored graph 410, nodes α1 and α5 have been assigned a same color and can be calibrated in parallel and nodes α2 and α3 have been assigned a same color and can be calibrated in parallel.

FIG. 5 is a circuit diagram of a quantum circuit 500 that has been partitioned into multiple subsections. The example quantum circuit 500 shown in FIG. 5 operates on three qubits, each represented by a respective horizontal line, and includes multiple unitary operations U₁-U₆. However, this is for illustrative purposes only and in practice the quantum circuit can operate on a larger number of qubits and include more unitary operations. The example quantum circuit 500 has been partitioned into multiple subsections 502-506. Each subsection is separated by a respective measurement operation. Identifiers for the subsections have been generated, e.g., by applying a hash function to a text representation of the subsections. As shown, since subsection 502 includes a same sequence of gates that are applied to the same qubits as subsection 506, the subsections have the same identifier “SFDTH5ASX”.

FIG. 6 is a flow diagram of an example process 600 for inserting compensation operations in a quantum circuit. The compensation operation is an operation that counteracts uncontrolled qubit rotations and can be a X, Y, or Z-phase compensation operation, as described above with reference to FIG. 1. For convenience, the process 600 will be described as being performed by a quantum computing system. For example, the quantum computing system 100 of FIG. 1, appropriately programmed in accordance with this specification, can perform the process 600.

The system identifies one or more operations in the quantum circuit that violate a generalized commutation relation with the compensation operation (step 602). An operation in the quantum circuit violates the generalized commutation relation with the compensation operation if an action of the operation is modified by the compensation operation up to a global phase, as described above with reference to FIG. 2.

For example, if the operation in the quantum circuit is a single qubit operation that acts on a respective qubit i, the operation violates the generalized commutation relation with the compensation operation when the generalized commutation relation is given by Rᵢ(α, θ₁)U=e^{iφ} URᵢ(α, θ₁), does not hold, where U represents the single qubit operation, Rᵢ(α, θ₁) represents the compensation operation (that acts on qubit i), and e^{iφ} represents a global phase. As another example, if the operation in the quantum circuit is a two-qubit operation that acts on qubits i and j, the operation violates the generalized commutation relation with the compensation operation when the generalized commutation relation is given by Rᵢ(α, θ₁)U=e^{iφ}URⱼ(β, θ₂), does not hold, where U represents the two-qubit operation, Rᵢ(α, θ₁) represents the compensation operation applied to qubit i where a represents a normalized vector around which to rotate (e.g., represents the Z, X, or Y axis) and θ₁ represents the rotation angle of operation Rᵢ, Rᵢ(β, θ₂) represents the compensation operation applied to qubit j where β represents a normalized vector around which to rotate (e.g., represents the Z, X, or Y axis) and θ₂ represents the rotation angle of operation Rⱼ, and e^{iφ} represents a global phase with free parameter φ.

The system then further identifies one or more operations in the quantum circuit that violate the generalized commutation relation with the compensation operation and are directly preceded by a reset operation (step 604). The system inserts the compensation operation directly before each of the one or more operations in the quantum circuit that violates the generalized commutation relation with the compensation operation and is not directly preceded by a reset operation (step 606). In some implementations the system can identify instances of the inserted compensation operations that are equivalent and remove one of the instances from the quantum circuit, e.g., using a Tableau simulation tool.

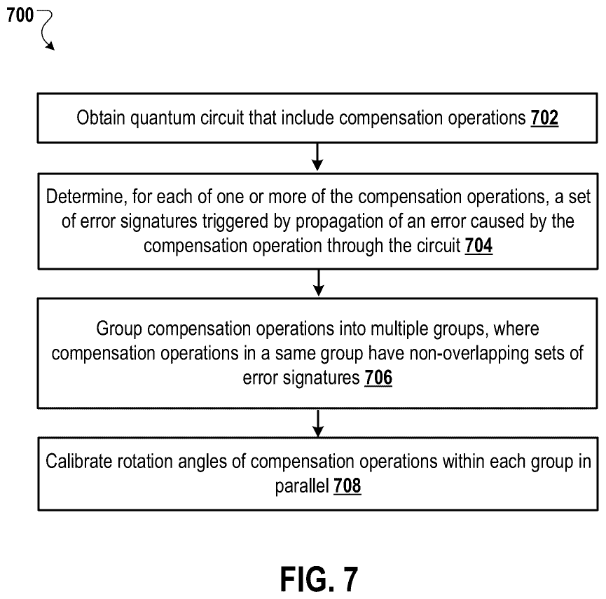

The system calibrates rotation angles of the compensation operations inserted into the quantum circuit (step 608). In some implementations the system can perform a parameter sweep approach to calibrate a rotation angle of a respective compensation operation. For example, the system can monitor an error signal, e.g., error detection event fraction signal, obtained after repeatedly applying a portion of the quantum circuit that includes the compensation operation whilst varying the rotation angle over a predetermined range of angles, e.g., range [−π, π], to identify a rotation angle that maximally aligns the qubit state with an expected qubit state. In other implementations the system can perform an adaptive optimization algorithm (e.g., Bayesian inference or a machine learning based optimizer) or phase estimation-based calibration method (e.g., a Ramsey experiment) to calibrate the rotation angles of the compensation operations inserted into the quantum circuit. The rotation angles of the compensation operations inserted into the quantum circuit can be calibrated in series or in parallel, e.g., using the example process described below with reference to FIG. 7.

In some implementations the system can store the calibrated rotation angles in a control and measurement system included in the quantum computing device. The control and measurement system can then retrieve the pre-calibrated rotation angles for subsequent executions of the quantum circuit (or executions of similar quantum circuits, as described below), without requiring recalibration.

In some implementations, the system can re-use calibrated rotation angles for different compensation operations at similar locations in the quantum circuit. For example, the system can partition the quantum circuit into multiple subsections, e.g., where each subsection is delimited by a respective reset and measurement operation. The system can then generate an identifier of each subsection, e.g., by applying a hash function to each subsection. For example, the system can map each subsection to a canonical text format that represents the subsections as respective strings, e.g., a QASM string or gate list string. The system can then apply a hash function to the strings to generate the identifiers. As another example, the system can represent the unitary of each subsection as a respective matrix and apply a hash function to the matrices to generate the identifiers. As another example, the system can input a Tableau representation of each subsection into the hash function to generate the identifiers.

In some implementations, identifiers can incorporate information relating to the context in which a subsection appears in the quantum circuit, e.g., information relating to preceding subsections. For example, the system can apply a hash function to a subsection to obtain a first hash value and apply a hash function to a subsection that directly precedes the subsection to obtain a second hash value. The system can then combine the first hash value and the second hash value to obtain the identifier of the subsection.

In either of the above-described implementations, the system identifies multiple subsections have a same identifier. The system can then calibrate rotation angles of compensation operations in one subsection of the multiple subsections with the same identifier and propagate the calibrated rotation angles to respective compensation operations in other subsections of the multiple subsections with the same identifier. This can reduce the number of calibrations performed during step 608.

FIG. 7 is a flow diagram of an example process 700 for calibrating compensation operations in a quantum circuit in parallel. For convenience, the process 700 will be described as being performed by a quantum computing system. For example, the quantum computing system 100 of FIG. 1, appropriately programmed in accordance with this specification, can perform the process 700.

The system obtains data specifying a quantum circuit that includes multiple compensation operations (step 702). The compensation operations are operations that counteract uncontrolled qubit rotations and can be X, Y, or Z-phase compensation operations, as described above with reference to FIG. 1. In some implementations, the compensation operations may have been inserted into the quantum circuit using the techniques described above with reference to FIG. 6.

For each compensation operation in the quantum circuit, the system determines a set of detectors triggered by propagation of an error caused by the compensation operation through the circuit (step 704). The detectors triggered by propagation of an error caused by a particular compensation operation through the circuit are qubits or measurement mechanisms in the quantum circuit that detect errors caused by the compensation operation. The detectors reveal identifiable patterns in measurement outcomes or intermediate quantum states that indicate the presence of an error. The type of detectors used can vary depending on the type of error introduced and the quantum circuit in which the compensation operation is applied. For example, in cases where the quantum circuit is an error correction quantum circuit, the detectors can be syndrome qubits in a stabilizer code, parity check qubits in a repetition code, or leakage detection ancilla qubits. As another example, in cases where the quantum circuit is an error mitigation quantum circuit, the detectors can be quantum non-demolition (QND) readout qubits, dynamical decoupling pulse monitors (qubits or sensors), leakage detection ancilla qubits, cross entropy benchmarking detectors, or ancilla qubit parity check measurements for post selection.

In some implementations, the system can determine the sets of detectors for the compensation operations in the quantum circuit by performing a Tableau simulation of the quantum circuit using a Tableau simulation tool. In other implementations the system can perform a different simulation, e.g., a Clifford circuit simulation or Monte Carlo based Pauli error propagation simulation, or perform experimental calibration and tomography, e.g., quantum process tomography or quantum detector tomography.

The system groups the compensation operations in the quantum circuit into multiple groups, where compensation operations in a same group have non-overlapping sets of detectors (step 706). Two sets of detectors are non-overlapping (also referred to as disjoint) if the sets do not have any common elements and overlap if the sets have one or more common elements. As an example, in cases where the detectors are syndrome qubits in a stabilizer code, the set of detectors for a compensation operation is a set of syndrome qubits that measure a flipped stabilizer outcome (which indicates an error). Multiple compensation operations can rely on a same syndrome qubit to detect errors caused by the compensation operations. However, when the syndrome qubit detects an error, the syndrome qubit measures a flipped stabilizer outcome but does not distinguish between the two candidate sources of error. Therefore, if one of the multiple compensation operations causes an error, the sets of detectors for the multiple compensation operations will overlap, since each set of detectors will include the syndrome qubit.

To group the compensation operations in the quantum circuit into multiple groups, the system maps the compensation operations and sets of detectors to a graph. The graph is constructed such that each node in the graph represents a respective compensation operation and pairs of nodes in the graph are connected by an edge when the sets of detectors for the two nodes in the pair overlap. The system performs a graph coloring algorithm on the graph to assign colors to the nodes in the graph, where adjacent nodes are assigned different colors. Example graph coloring algorithms include, a greedy coloring algorithm, Welsh-Powell, or Recursive Largest First (RLF) Algorithm. The system then groups compensation operations that correspond to nodes in the graph with a same color in a same group. The number of groups generated at step 706 is therefore equal to the number of colors in the graph.

The system calibrates rotation angles of compensation pulses within each group in parallel (step 708). For example, the system can perform a parameter sweep approach, adaptive optimization algorithm, or phase estimation-based calibration method to calibrate rotation angles of compensation pulses within each group in parallel, as described above with reference to FIG. 6.

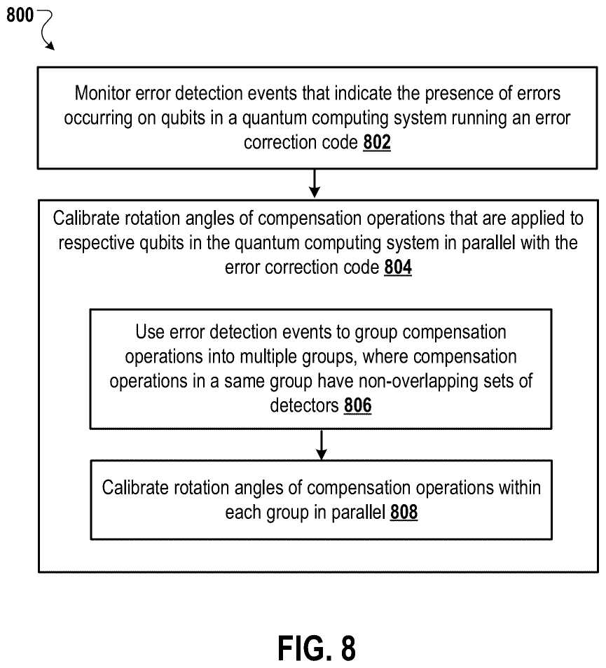

FIG. 8 is a flow diagram of an example process 800 for calibrating compensation operations in-situ whilst error correction is running. For convenience, the process 800 will be described as being performed by a calibration system in data communication with a quantum computing device running an error correction procedure on a plurality of qubits. For example, the quantum computing system 100 of FIG. 1, appropriately programmed in accordance with this specification, can perform the process 800.

The system monitors error detection events that indicate a presence of errors occurring on qubits included in the quantum computing device whilst an error correction quantum circuit is executed (step 802). The system calibrates rotation angles of compensation operations in the error correction quantum circuit that operate on respective qubits in parallel with the error correction procedure (step 804). The system uses the monitored error detection events to determine a set of detectors triggered by propagation of an error caused by the compensation operation for each compensation operation in the error correction quantum circuit and identify multiple groups of compensation operations, where compensation operations in a same group have non-overlapping sets of detectors (step 806). The system then calibrates rotation angles of compensation pulses in each group in parallel (step 808). Steps 806 and 808 are similar to steps 704-708 of example process 700 described above with reference to FIG. 7. For brevity, details are not repeated.

Implementations of the digital and/or quantum subject matter and the digital functional operations and quantum operations described in this specification can be implemented in digital electronic circuitry, suitable quantum circuitry or, more generally, quantum computational systems, in tangibly-embodied digital and/or quantum computer software or firmware, in digital and/or quantum computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers to be “configured to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum processors or both, or any other kind of central digital and/or quantum processing unit. Generally, a central digital and/or quantum processing unit will receive instructions and digital and/or quantum data from a read-only memory, a random access memory, or quantum systems suitable for transmitting quantum data, e.g. photons, or combinations thereof.

The essential elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include or be operatively coupled to receive digital and/or quantum data from or transfer digital and/or quantum data to, or both, one or more mass storage devices for storing digital and/or quantum data, e.g., magnetic, magneto-optical disks, optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more non-transitory machine-readable storage media, and that are executable on one or more digital and/or quantum processing devices. The systems described in this specification, or portions of them, can each be implemented as an apparatus, method, or system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a quantum computing device, the method comprising:
identifying one or more operations in a quantum circuit that each violate a commutation relation with a compensation operation, wherein the compensation operation counteracts uncontrolled qubit rotations;
inserting the compensation operation directly before each of the one or more operations in the quantum circuit that violate the commutation relation with the compensation operation; and
calibrating rotation angles of the compensation operations inserted into the quantum circuit.

2. The method of claim 1, wherein calibrating rotation angles of the compensation operations inserted into the quantum circuit comprises:
determining, for each compensation operation, a set of detectors triggered by propagation of an error caused by the compensation operation through the circuit;
determining a plurality of groups of compensation operations, wherein compensation operations in a same group have non-overlapping sets of detectors; and
calibrating rotation angles of compensation pulses in each group.

3. The method of claim 2, further comprising calibrating rotation angles of compensation pulses in each group in parallel.

4. The method of claim 2, wherein determining the plurality of groups of compensation operations comprises:
mapping the compensation operations and sets of detectors to a graph, wherein each node in the graph represents a respective compensation operation and two nodes are connected by an edge when the sets of detectors for the two nodes overlap;
performing a graph colouring algorithm to assign colours to the nodes in the graph, wherein adjacent nodes are assigned different colours; and
grouping compensation operations that correspond to nodes in the graph with a same colour in a same group.

5. The method of claim 2, wherein determining, for each compensation operation, a set of detectors triggered by propagation of an error caused by the compensation operation through the circuit comprises performing a Tableau simulation using a Tableau simulation tool.

6. The method of claim 2, wherein the detectors comprise detectors or measured deviations from known circuit outputs.

7. The method of claim 1, wherein the one or more operations in the quantum circuit that each violate the commutation relation with the compensation operation excludes operations in the quantum circuit that violate the commutation relation with the compensation operation and directly preceded by a reset operation.

8. The method of claim 1, wherein an operation violates the commutation relation with the compensation operation if an action of the operation is modified by the compensation operation up to a global phase.

9. The method of claim 1, wherein the operation is a single qubit operation and commutation relation is given by Rᵢ(α, θ₁)U=e^{iφ}URᵢ(α, θ₁), where U represents the single qubit operation in the quantum circuit that acts on qubit i, Rᵢ(α, θ₁) represents a compensation operation applied to qubit i where α represents a normalized vector around which to rotate and θ₁ represents a rotation angle of the compensation operation Rᵢ, and e^{iφ} represents a global phase with free parameter φ.

10. The method of claim 1, wherein the operation is a two-qubit operation and the commutation relation is given by Rᵢ(α, θ₁)U=e^{iφ}URⱼ(β, θ₂), where U represents the two-qubit operation in the quantum circuit that acts on qubits i and j, Rᵢ(α, θ₁) represents a compensation operation applied to qubit i where α represents a normalized vector around which to rotate and θ₁ represents a rotation angle of the compensation operation Rᵢ, Rᵢ(β, θ₂) represents a compensation operation applied to qubit j where β represents a normalized vector around which to rotate and θ₂ represents a rotation angle of the compensation operation Rⱼ, and e^{iφ} represents a global phase with free parameter φ.

11. The method of claim 1, further comprising:
partitioning the quantum circuit that comprises the compensation operations into a plurality of subsections;
generating an identifier of each subsection, comprising applying a hash function to each subsection;
determining that multiple subsections have a same identifier;
calibrating rotation angles of compensation operations in one subsection of the multiple subsections; and
propagating the calibrated rotation angles to respective compensation operations in other subsections of the multiple subsections.

12. The method of claim 11, wherein each subsection in the plurality of subsections is delimited by a respective measurement and reset operation.

13. The method of claim 11, wherein propagating the calibrated rotation angles to respective compensation operations in other subsections of the multiple subsections comprises inserting an additional compensation operation at a start of each other subsection.

14. The method of claim 11, wherein generating an identifier of a subsection of the quantum circuit comprises:
applying a hash function to the subsection to obtain a first hash value;
applying a hash function to a subsection that directly precedes the subsection to obtain a second hash value; and
combining the first hash value and the second hash value to obtain the identifier of the subsection.

15. The method of claim 1, wherein the quantum circuit comprises quantum error correction circuit or an error mitigation circuit.

16. The method of claim 1, wherein the compensation operation comprises an X, Y, or Z-phase compensation rotation.

17. The method of claim 1, further comprising storing the calibrated rotation angles in a control and measurement system included in the quantum computing device.

18. The method of claim 17, further comprising retrieving, by the control and measurement system, the calibrated rotation angles to execute the quantum circuit.

19. A quantum computing device comprising:
a plurality of qubits;
a control and measurement system configured to operate the plurality of qubits; and
a classical computing device coupled to the control and measurement system;
wherein the quantum computing device is configured to perform operations comprising:
identifying one or more operations in a quantum circuit that each violate a commutation relation with a compensation operation, wherein the compensation operation counteracts uncontrolled qubit rotations;
inserting the compensation operation directly before each operation in the quantum circuit that violates the commutation relation with the compensation operation; and
calibrating the rotation angles of the compensation operations inserted into the quantum circuit.

20. An apparatus, comprising a calibration system in data communication with a quantum computing device running an error correction procedure on a plurality of qubits, wherein the calibration system is configured to:
monitor error detection events that indicate a presence of errors occurring on the plurality of qubits; and
calibrate, in parallel with the error correction procedure, rotation angles of compensation operations that operate on respective qubits of the plurality of qubits, comprising:
determining, using the monitored error detection events and for each compensation operation, a set of detectors triggered by propagation of an error caused by the compensation operation;
determining a plurality of groups of compensation operations, wherein compensation operations in a same group have non-overlapping sets of detectors; and
calibrating rotation angles of compensation pulses in each group in parallel.

21. A method performed by a calibration system in data communication with a quantum computing device running an error correction procedure on a plurality of qubits, the method comprising:
monitoring error detection events that indicate a presence of errors occurring on the plurality of qubit; and
calibrating, in parallel with the error correction procedure, rotation angles of compensation operations that operate on respective qubits of the plurality of qubits, comprising:
determining, using the monitored error detection events and for each compensation operation, a set of detectors triggered by propagation of an error caused by the compensation operation;
determining a plurality of groups of compensation operations, wherein compensation operations in a same group have non-overlapping sets of detectors; and
calibrating rotation angles of compensation pulses in each group in parallel.
